(19) United States
(12) Patent Application Publication
(10) Pub. No.: US 2026/0158812 A1
(43) Pub. Date: Jun. 11, 2026

(54) 3D CARD

(71) Applicant: Hae-Yong CHOI, Seoul (KR)

(72) Inventor: Hae-Yong CHOI, Seoul (KR)

(21) Appl. No.: 19/380,160

(22) Filed: Nov. 5, 2025

(30) Foreign Application Priority Data
Dec. 6, 2024 (KR) 10-2024-0180799
Aug. 18, 2025 (KR) 10-2847562

(51) Int. Cl. B42D 15/02; B42D 15/04; G02B 30/22

(52) U.S. Cl. CPC B42D 15/027; B42D 15/042; G02B 30/22

(57) ABSTRACT

The present invention relates to a 3D card in which a horizontal fold line is provided between a card center portion and a card bottom surface, a lower fold line is provided between the card bottom surface and a lower blocking surface, vertical fold lines are provided between left and right sides of the card center portion, left and right blocking films, and a lens plate, respectively, and an upper fold line is provided between an external light window and the upper blocking surface, so that the card bottom surface rotates from a lower portion to front and rear surfaces of a card, thereby forming a single card or a three-dimensional device.

### TECHNICAL FIELD

The present invention relates to a three-dimensional (3D) card comprising a card image and a three-dimensional image observation device combined to form a single card.

### BACKGROUND ART

Cards are printed materials comprising photographs, drawings, images, etc. on a rectangular flat surface and are used for purposes such as collection cards, Christmas cards, birthday cards, and postcards.

Conventionally, such cards have only provided simple printed images, and no devices have been presented that show three-dimensional images related to the card together with the card image.

Further, conventional 3D viewer devices are film-type devices through which light is transmitted from a rear surface, and since a transmission surface must be formed, there were limitations on card image configuration and size, such films incur excessive manufacturing costs due to the use of photographic paper, and their manufacture and use are regulated due to the use of chemical substances in a film itself.

In addition, the card should have an image provided on an entire front surface as a single panel, but when an additional device is added, a portion of the card surface becomes separated or disconnected due to the additional device, thereby degrading the marketability and functionality of the card.

Therefore, there is a need for a configuration method for a three-dimensional card that provides a card image on one single panel card seamlessly, enables three-dimensional viewing of card-related images without using the film, and simultaneously provides 3D images together with the card image.

### DISCLOSURE

### Technical Problem

The present invention provides a method and a structure in which a card image is implemented on a front surface of a single card, while a rear surface combines a three-dimensional image viewable in three dimensions with a three-dimensional observation structure in a thin film form that enables three-dimensional observation of such three-dimensional images.

### Technical Solution

The present invention includes a single card and a three-dimensional image provided on a rear surface of the card.

An external light window is configured to brightly illuminate a three-dimensional image formed on the rear surface of the card with external light, and a reinforcement member is provided and the external light window is configured on the reinforcement member.

The reinforcement member and the external light window are configured on the rear surface of the card so that an image of a front surface of the card is expressed seamlessly.

One of front and rear directions of the reinforcement member is concatenated with left and right rear surfaces of the card, and the other is concatenated with an upper blocking surface.

A lens plate having left and right lenses and left and right blocking films are configured at both left and right sides of a card center portion having the three-dimensional image on the rear surface of the card.

An upper blocking surface is configured at an upper portion of the lens plate, and is connected to one end of the reinforcement member.

A lower portion of the lens plate is configured to be concatenated with a lower blocking surface, and the lower blocking surface is configured to be concatenated with a lower end of the card.

Further, a horizontal fold line is provided between the card center portion and a card bottom surface, a lower fold line is provided between the card bottom surface and the lower blocking surface, and vertical fold lines are provided between the card center portion, the left and right blocking films, and the lens plate, respectively.

### Advantageous Effects

According to the present invention, there is an effect of providing a card image on a front surface of the card and enabling observation of a three-dimensional image on the rear surface of the card by providing three-dimensional left and right images on the rear surface of the card.

A structure of an external light window formed by a reinforcing member acts as a supporting force that interfaces with the card and the three-dimensional observation device, thereby providing an effect of supporting and operating an entire structure of the present invention, and as a lower portion of the card rotates from the bottom of the card toward the front and rear surfaces, there is an effect of conversion into a single card or three-dimensional device.

That is, when the present invention is used as a three-dimensional image, the lower portion of the card is configured to rotate toward the rear surface while the lower portion of the card is converted to the lower portion of the three-dimensional observation device, thereby providing the effect of functioning as a card when folded and as a three-dimensional observation device when in use.

Further, since the external light window structure is configured on the rear surface of the card, there is an effect of providing the card image as a single card image seamlessly.

Further, by configuring left and right blocking films at both left and right ends of a central portion of the card in conjunction with left and right sides of a lens plate, left and right three-dimensional lenses on the rear surface of the card are horizontally aligned with an optical axis, thereby providing an effect of enabling observation of three-dimensional images.

Further, a reinforcement member is provided between the central portion of the card and an upper blocking surface, and an external light window coupled based on such a reinforcement member provides support force so that the entire structure is firmly supported and operated when a user uses the present invention. Further, such an external light window may be configured at a lower portion based on the reinforcement member to enlarge an area of the external light window by 50% or more. Accordingly, external light incident from the outside is irradiated onto a three-dimensional image surface, thereby implementing a clear three-dimensional image of 1.5 times or more without a separate lighting device.

Therefore, the present invention may provide, in a single card structure, a card image such as photographs or pictures as a single card seamlessly on the front surface, and enable observation of images related to the card as clear three-dimensional images on the rear surface of the card, so that the present invention can be applied to birthday cards, Christmas cards, business cards, and the like, and collected and stored like collection cards or signature cards.

### DESCRIPTION OF DRAWINGS

FIG. 1 is an overall configuration explanatory diagram of the present invention.

FIG. 2 is a side configuration view of a configuration explanatory diagram of the present invention.

FIG. 3 is a Reference Diagram 1 for use when used in a three-dimensional structure.

FIG. 4 is a Reference Diagram 2 for use when used in the three-dimensional structure.

### BEST MODE

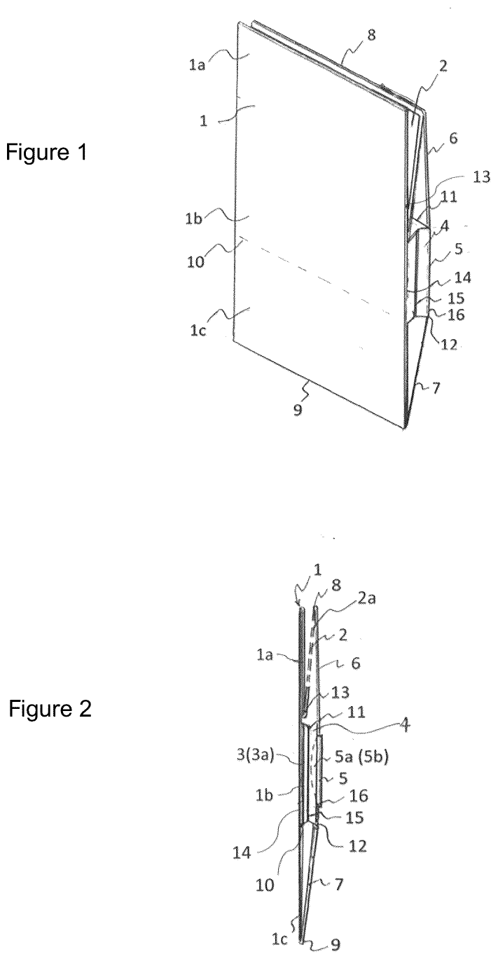

As illustrated in FIGS. 1 and 2, the present invention includes: a single card 1; three-dimensional left and right eye images 3 and 3a provided on a rear surface of the card 1; and a reinforcement member 2a for configuring an external light window 2 that brightly illuminates the three-dimensional left and right eye images 3 and 3a formed on the rear surface of the card 1 with external light, wherein one side of the reinforcement member 2a in front and rear directions is concatenated with the rear surface of the card 1 and the other side is concatenated with an upper blocking surface 6, and an upper surface portion of the reinforcement member 2a is provided with the external light window 2 based on the reinforcement member 2a.

Left and right blocking films 4 and 4a are formed on both left and right sides of a card center portion 1b having left and right eye images 3 and 3a on a rear surface and a lens plate 5 having left and right lenses 5a and 5b.

An upper blocking surface 6 is connected to one end of a reinforcement member 2a of an external light window 2 at an upper portion of the lens plate 5, and is concatenated with a lower blocking surface 7 at a lower portion of the lens plate 5. The lower blocking surface 7 is concatenated with a card bottom surface 1c.

Further, the present invention includes: a horizontal fold line 10 between the card central portion 1b and the card bottom surface 1c; a lower fold line 9 between the card bottom surface 1c and the lower blocking surface 7; and vertical fold lines 14, 15, and 16 respectively formed between the left and right sides of the card central portion 1b and the left and right blocking films 4 and 4a and the lens plate 5.

As illustrated in FIG. 1, the present invention is configured as a single card 1 in which an image or a photo of the front surface of the card 1 is configured seamlessly, and as illustrated in FIGS. 1 and 2, a three-dimensional observation device is combined with a portion of the card 1 on the rear surface of the card 1 to form a portion of the card.

For convenience of description, the structure of the card 1 is divided into three parts in a vertical direction: a card upper portion 1a, a card central portion 1b, a card lower portion 1c.

Such a three-dimensional observation device includes a three-dimensional image 3 composed of the three-dimensional left and right eye images 3a and 3b on a rear surface of the card central portion 1b as illustrated in FIG. 1.

A reason for forming the three-dimensional left and right eye images 3a and 3b on the rear surface of the card 1 as described above is to configure the card 1 and the three-dimensional image in a single card 1 structure.

An external light window 2 that brightly illuminates a surface of the three-dimensional image 3 by external light being incident is formed at an upper end of the three-dimensional image 3 of the card center portion 1b.

Such an external light window 2 first includes a reinforcement member 2a made of a transparent material such as plastic, and the external light window 2 is formed based on such a reinforcement member 2a.

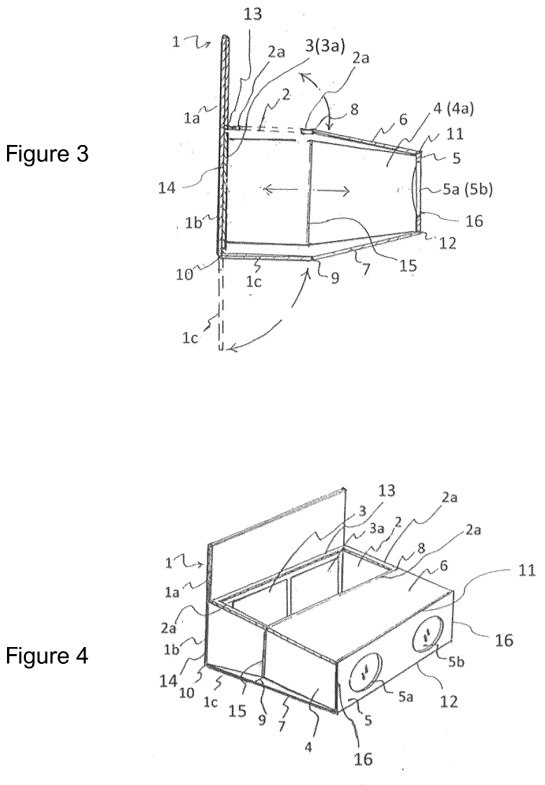

As illustrated in FIGS. 3 and 4, a periphery of the external light window 2 provides a clearer three-dimensional image as more external light is incident on an interior.

Therefore, left and right connection surfaces of the external light window 2 are portions that bear a greatest load, which connect the card 1 and the lens plate 5. As an actual application result, the periphery of the external light window 2 is formed as a narrow strip having a small area with a width of 5 mm, and according to an application of such a configuration, the periphery became twisted and broken after 2 to 3 uses, making it unusable. Therefore, even without repeated use, a peripheral strip portion of the external light window 2 becomes damaged and unusable, making it impossible to configure the external light window 2.

To solve these problems, as illustrated in FIG. 4, in the present invention, the reinforcement member 2a may be made of one material of hard paper, a plastic sheet, a reinforcement tape, and a transparent film over left and right surfaces and front and rear surfaces of the external light window 2 connected to the card 1, and the external light window 2 may be configured on an upper surface of the reinforcement member 2 based thereon, and a size of the external light window 2 is configured to be as large as possible.

An area of the external light window 2 configured by the reinforcement member 2 a may be enlarged by approximately 50% or more by a supporting force of the reinforcement member 2a, thereby enabling viewing of three-dimensional images which are approximately 1.5 times clearer or more.

Since printing, etc., is impossible on a surface of the external light window 2, the external light window 2 is configured on the rear surface of the card 1. Such a configuration does not affect a graphic composition of the card image on the front surface of the card 1.

In the present invention described above, an upper end of the lens plate 5 is linked to the upper blocking surface 6 connected to the external light window 2 and a lower end of the lens plate 5 is linked to the lower blocking surface 7, and a lower end of the lower blocking surface 7 is linked to a lower end of the card lower portion 1c again.

In respective components of the present invention described above, an upper end of the card center portion 1b and a lower end of the external light window 2 are linked by a horizontal fold line 13, an upper end of the external light window 2 and an upper end of the upper blocking surface 6 are linked by an upper fold line 8, a lower end of the upper blocking surface 6 and the upper end of the lens plate 5 are linked by a horizontal fold line 11, the lower end of the lens plate 5 and an upper end of the lower blocking surface 7 are linked by a horizontal fold line 12, and a lower end of the lower blocking surface 7 is linked to a lower end of the card lower portion 1c by a lower fold line 8.

A left end of the card center surface 1b and a front of a left blocking film 4 are linked with the vertical fold line 14 and a rear of the left blocking film 4 is linked with the lens plate 5 and the vertical fold line 16, and a vertical fold line 15 is configured at a center of the left blocking film 4 so that the left blocking film 4 is folded and unfolded in front and rear directions.

A configuration of a right blocking film 4a is also configured with the same logic as the configuration of the left blocking film 4.

In the present invention, among left and right sides of the card center portion 1b, the left side is linked to one side of the left blocking film 4 and the right side is linked to one side of the right blocking film 4a, and the other side of the left blocking film 4 is again linked to a left end of the lens plate 5, and the other side of the right blocking film 4a is also linked to a right end of the lens plate 5.

Further, the present invention includes a horizontal fold line 10 provided between the card center portion 1b and the card bottom surface 1c, a vertical fold lines 14, 15, and 16 provided between left and right sides of the card center portion 1b and the left and right blocking films 4 and 3a and between the left and right blocking films 4 and 4a and the lens plate 5, an upper fold line 8 provided between the external light window 2 and the upper blocking surface 6, and a lower fold line 9 provided between the card bottom surface 1c and the lower blocking surface 7.

A reason for providing the left blocking film 4 and the right blocking film 4a on the rear surface 1b of the card center portion 1b, i.e., in both left and right direction of the three-dimensional left and right eye images 3a and 3b, respectively, and linking the left blocking film 4 and the right blocking film 4a with the lens plate 5 is to observe the three-dimensional image by configuring centers of the left and right eye images 3a and 3b to be aligned with optical axes of the left and right lenses 5a and 5b of the lens plate 5.

When used for three-dimensional observation, as illustrated in FIGS. 3 and 4, when the user presses the upper fold line 8 and the lower fold line 9, as the left and right blocking films (4, 4a) are unfolded, the center of the left and right eye images 3 and 3a configured on the rear surface of the card 1 is aligned with the optical axis of the left and right lenses 5a and 5b configured on the lens plate 5 by the reinforcement member 2a.

Further, the weighted lens plate 5 and the rear surface of the card 1 are firmly connected by the reinforcing bar 2a, and a horizontality of the optical axis is also firmly maintained.

Further, as illustrated in FIGS. 1 and 2, when the card bottom surface 1a is configured as a vertical straight line by the horizontal fold line 10, an entire structure of the card 1 becomes a single card 1 structure.

As illustrated in FIGS. 3 and 4, when the user presses the upper fold line 8 and the lower fold line 9, the left and right blocking films 4 and 4a are unfolded as the card bottom surface 1c is folded in the rear direction, thereby converting into a three-dimensional observation device that moves the lens plate 5 to a focal distance position of each lens.

When the upper fold line 8 and the lower fold line 9 are folded again, the 3D card is reduced to a card form having a thin film structure as illustrated in FIGS. 1 and 2.

That is, as illustrated in FIGS. 3 and 4, when the card bottom surface 1c is rotated rearward by the horizontal fold line 10 formed between the card center portion 1b and the card bottom surface, and is formed as the bottom surface with the lower blocking surface 7, thereby forming the three-dimensional observation device as the left and right blocking films 4 and 4a are unfolded in the front and rear directions.

When the card bottom surface 1c rotates and returns to the lower portion of the card 1, the 3D card becomes a thin film card 1 form as illustrated in FIG. 1.

The present invention is configured as a single card 1 in which a front surface of a structure is seamless, a center of a three-dimensional image is aligned with the optical axes of the left and right lenses 5a and 5b by the left and right blocking films 4 and 4a, the card bottom surface 1c is rotated rearward by the horizontal fold line 10, and the periphery of the external light window 2 is configured based on the reinforcement member 2a, thereby firmly supporting the external light window 2.

Accordingly, according to the present invention, the external light window 2 having the three-dimensional left and right eye images 3 and 3a, the left and right blocking films 4 and 4a, and the reinforcement member 2a on the rear surface of the single card 1 and the lens plate 5 having the left and right lenses 5a and 5b are configured in the card 1 itself, so that the image and the three-dimensional image of the card 1 may be provided in a single card.

That is, the present invention includes a single card 1 and a three-dimensional observation structure combined with the rear surface of the card 1, and such a structure configures a three-dimensional card in which the three-dimensional image is provided on the rear surface of the card 1 as a single card image.

Accordingly, the present invention can be applied to three-dimensional cards such as 3D Christmas cards, 3D birthday cards, 3D business cards providing three-dimensional images, 3D autograph cards of celebrities including sports figures and entertainers, and 3D collection cards featuring animation and cartoon characters.

### EXPLANATION OF REFERENCE NUMERALS AND SYMBOLS

1. Card
1a. Card top surface
1b. Card center portion
1c. Card bottom surface
2. External light window
2a. Reinforcement member
3. Left eye image
3a. Right eye image
4. Left blocking film
4a. Right blocking film
5. Lens plate
5a. Left lens
5b. Right lens
6. Upper blocking surface
7. Lower blocking surface
8. Upper fold line
9. Lower fold line
10, 11, 12, 13. Horizontal fold line
14, 15, 16. Vertical fold line

1-2. (canceled)

3. A 3d card, comprising:
a single sheet card (1) having a front surface and a rear surface,
wherein the front surface is configured to display a continuous image;
an upper blocking surface (6) formed on an upper portion of the rear surface of the card (1);
an upper fold line (8) formed along one side of the upper blocking surface (6);
a reinforcement member (2a) extending from the upper fold line (8) and defining a light incident passage;
an external light window (2) formed in the reinforcement member (2a) and configured to introduce external light into the card;
a three-dimensional image (3) disposed at a central portion of the rear surface of the card (1);
a lens plate (5) disposed in front of the three-dimensional image (3) such that external light introduced through the external light window (2) is directed toward the three-dimensional image (3) through the lens plate (5); and
a lower fold line (9) formed at a lower portion of the card (1),
wherein:
folding of the card (1) along the upper fold line (8) and the lower fold line (9) forms a light-shielding chamber between the reinforcement member (2a) and the rear surface of the card (1);
the light incident passage defined by the reinforcement member (2a) establishes an optical path from the external light window (2) to the three-dimensional image (3); and
unfolding of the card (1) changes a relative positional relationship between the lens plate (5) and the three-dimensional image (3) to permit observation of the three-dimensional image (3) through the lens plate (5).
